(19) United States
(12) Patent Application Publication
(10) Pub. No.: US 2005/0191966 A1
(43) Pub. Date: Sep. 1, 2005

(54) Receiver and electronic apparatus including receiver

(76) Inventor: Yoshinori Katsuta, Okazaki-shi (JP)

Correspondence Address: POSZ LAW GROUP, PLC, 12040 SOUTH LAKES DRIVE, SUITE 101, RESTON, VA, 20191, US

(21) Appl. No.: 11/059,632

(22) Filed: Feb. 17, 2005

(30) Foreign Application Priority Data
Feb. 18, 2004 (JP) 2004-41758

(51) Int. Cl. H04B 1/00

(52) U.S. Cl. 455/68; 340/825.72; 375/316; 340/447

(57) ABSTRACT

The receiver includes an antenna for receiving a radio wave transmitted from a communication target, a demodulator extracting a baseband signal from the radio wave received by the antenna, and a filter device for low-pass filtering the baseband signal extracted by the demodulator. The filter device is configured to vary a cut-off frequency thereof in accordance with a command signal received from outside the receiver.

### CROSS-REFERENCE TO RELATED APPLICATION

This application is related to Japanese Patent Applications No. 2004-41758 filed on Feb. 18, 2004, the contents of which are hereby incorporated by reference.

### BACKGROUND OF THE INVENTION

1. Field of the Invention

The present invention relates to a receiver and an electronic apparatus including the receiver.

2. Description of Related Art

Control systems having an electronic apparatus which is installed in a vehicle to perform control of electric loads and information processings through communication with the outside have been in practical use. The most common one of such control systems is a remote keyless entry system (abbreviated as “RKE system” hereinafter). In this system, lock/unlock of doors of a vehicle is performed when an electronic apparatus installed in the vehicle receives and validates a radio wave containing information specific to the vehicle, which is transmitted from a portable device carried by a user of the vehicle when the user presses a button of the portable device.

A smart keyless entry system (referred to as “SMART system” hereinafter) as disclosed in Japanese Patent Application Laid-open No. 2003-157483, for example, is also becoming widespread. The SMART system has a configuration in which lock/unlock of doors of a vehicle is allowed when a vehicle-installed electronic apparatus receives and validates a reply signal transmitted from a portable device carried by a user of the vehicle as an electronic key transmits when it has entered a certain radio-communication range around the vehicle, Once the electronic apparatus allows lock/unlock of doors, the user can lock or unlock the doors by manipulating a switch installed outside the door.

A tire air pressure monitoring system (abbreviated as “TPM system” hereinafter) is also proposed as disclosed in Japanese Patent Application Laid-open No. 2001-250186, The TPM system has a configuration in which a sensor installed in each of the wheels of a vehicle detects air pressure of a tire and transmits a radio wave containing data representing the detected air pressure, and an vehicle-installed electronic apparatus receives this radio wave to monitor the tire air pressure.

A general structure of a receiver included in the vehicle-installed electronic apparatus used for the RKE system is explained below with reference to FIG. 6. As shown in this figure, a radio wave for the RKE system having a frequency of 315 MHz, for example, transmitted from a portable device is received by an antenna 11 of the receiver 101. The output signals of the antenna 11 are subjected to band-pass filtering at a BPF (band-pass filter) 13, so that a signal corresponding to the 315-MHz band radio wave is extracted as a received signal. The received signal extracted by the BPF 13 is amplified by an amplifier 15 so that it has a predetermined amplitude level, and then inputted to a mixer 17 for frequency conversion.

The mixer 17 mixes the received signal outputted from the amplifier 15 with a frequency-converting signal having a frequency of 304.3 MHz, for example, so that the received signal is converted into a 10.7-MHz band intermediate-frequency signal.

The intermediate-frequency signal outputted from the mixer 17 passes through a BPF 21 that allows only a 10.7-MHz band signal to pass. The intermediate-frequency signal that has passed through the BPF 21 is amplified by an amplifier 23, and then enters a detector circuit 25. The detector circuit 25 outputs a baseband signal (an information-containing signal that was used for modulating a carrier wave at the portable device).

The baseband signal outputted from the detector circuit 25 enters an LPF (low-pass filter) 27 serving as a baseband filter so that its frequency components over a predetermined cut-off frequency are eliminated. Subsequently, it is shaped by a waveform shaping circuit 29 so as to have a rectangular wave shape.

The baseband signal shaped by the waveform shaping circuit 29 is supplied to a control device (not shown) as a demodulated signal. The control device generates, from the demodulated signal outputted from the receiver 101, binary data to be used for information processings by detecting signal levels (high level/low level), or by detecting time intervals between signal edges. The amplifier 23 also outputs an RSSI signal indicative of the intensity of the received signal to the control device, so that the control device can judge whether or not the radio wave transmitted from the portable device is being received.

In the RKE system, the communication bit rate is set at a lower value within the scope of not harming its system response in order to obtain a longer communication range between the portable device and the vehicle-installed electronic apparatus. Accordingly, the cut-off frequency of the LPF 27 is set at a relatively low value (1 kHz, for example).

That is because if the communication bit rate is set low and the frequency of the baseband signal is therefore low, it becomes possible to lower the cut-off frequency of the LPF 27 of the receiver 101, thereby reducing the noise passing through the LPF 27 and improving SIN as shown in the graph of FIG. 7. In the graph of FIG. 7, the vertical axis represents sensitivity of the antenna 11 (open-ended output voltage of the antennal 11). In this graph, smaller values along the vertical axis mean higher sensitivities and longer communication ranges.

Generally, the SMART system and TPM system use the same radio frequency band and the same modulation scheme as the RKE system. Accordingly, the receiver 101 shown in FIG. 6 can be used also for them. However, the SMART system and TPM system require faster responsiveness than the RKE system, and the communication bit rate is therefore set higher. Accordingly, the cut-off frequency of the baseband filter (LPF 27) of the receiver has to be set higher when it is used for the SMART system or the TPM system.

Thus, for using the receiver 101 shown in FIG. 6 as a receiver for the SMART system or the TPM system, it is necessary to make a setting in order to enhance the system response at the sacrifice of the communication range. For example, the cut-off frequency of the baseband filter is set at 2.5 kHz when used for the SMART system, and 5 kHz when used for the TPM system.

Hence, to equip a vehicle with all of the three systems (the RKE system, SMART system, and TPM system), it has been necessary to mount on the vehicle three receivers having the same structure but being different in the cut-off frequency of the baseband filter in order to ensure required communication performances (sensitivity and system response) different among the three systems. For the reason described above, the vehicle-installed electronic apparatus has been expensive and large in size.

It may occur that one receiver 101 is used in common for the RKE system, SMART system and TPM system. However, in this case, it is not possible to satisfy the different communication performances (communication range and system response) required of the three different systems. To be more specific, when one receiver 101 is used in common for the three systems, the cut-off frequency of the baseband filter (LPF 27) has to be set at a frequency (5 kHz in the TPM system) to a value that matches the frequency of the baseband signal in one of the three systems that uses the highest communication bit rate. However, in this setting, the communication performance (communication range) required of the RKE system cannot be ensured.

### SUMMARY OF THE INVENTION

The receiver of the invention has a structure including:
an antenna receiving a radio wave transmitted from a communication target;
a demodulator extracting a baseband signal from the radio wave received by the antenna; and
a filter device low-pass filtering the baseband signal extracted by the demodulator, the filter device being configured to vary a cut-off frequency thereof in accordance with a command signal received from outside the receiver.

With this configuration, it becomes possible to enhance the sensitivity (communication range) when receiving a radio wave for a system having a low communication bit rate (low baseband signal frequency), to enhance the system response when receiving a radio wave for a system having a high communication bit rate, and to set the sensitivity and the system response at moderate levels when receiving a radio wave for a system having a moderate communication bit rate.

With the receiver of the invention, control systems configured to receive different kinds of radio waves that have the same frequency band, are modulated by the same modulation scheme, and are different in a baseband-signal frequency can be implemented with a relatively smaller circuit configuration, because the different kinds of the radio waves can be received by the single receiver, and a single control device can perform radio wave receiving operations for all of the different kinds of the radio waves without difficulty.

The electronic apparatus of the invention includes the above described receiver and a control device outputting the command signal to the receiver in order that the receiver receives, on an alternating basis, different kinds of radio waves which have the same frequency band, are modulated by the same modulation scheme, and are different in a baseband-signal frequency for obtaining information contained in the different kinds of the radio waves.

The electronic apparatus may be of a vehicle-installed type, and the communication target may be a portable device carried by a user of the vehicle.

The different kinds of the radio waves may include at least two of a radio wave for a remote keyless entry system transmitted from the portable device, a radio wave for smart keyless entry system transmitted from the portable device, and a radio wave for a tire air pressure monitoring system transmitted from a sensor installed in each of wheels of the vehicle.

The filter device may include a plurality of low-pass filters having different cut-off frequencies, and a selector switch that selects one of the plurality of the low-pass filters in accordance with the command signal.

### BRIEF DESCRIPTION OF THE DRAWINGS

In the accompanying drawings:

FIG. 1 is a block diagram showing a structure of a vehicle-installed electronic apparatus according to an embodiment of the invention;

FIG. 2 is a block diagram showing a structure of a receiver included in the vehicle-installed electronic apparatus;

FIG. 3A is a time chart showing filter selecting operations performed by a control device included in the vehicle-installed electronic apparatus when the vehicle is parked;

FIG. 3B is a time chart showing a filter selecting operations performed by the control device when the vehicle is running;

FIG. 4 is a time chart showing processings performed by a microcomputer of the control device;

FIG. 5 is a time chart showing processings performed by a microcomputer of a control device included in a variant of the vehicle-installed electronic apparatus according to the embodiment of the invention;

FIG. 6 is a block diagram showing a structure of a conventional vehicle-installed electronic apparatus; and

FIG. 7 is a graph showing relationship between a communication bit rate and a sensitivity.

### PREFERRED EMBODIMENTS OF THE INVENTION

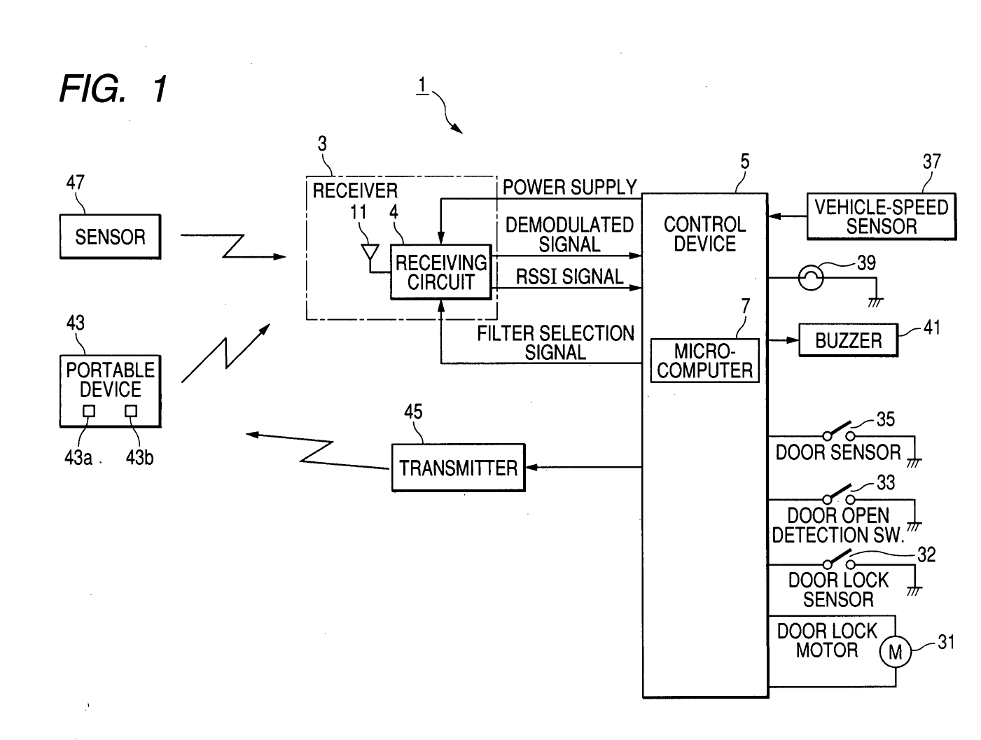

FIG. 1 is a block diagram schematically showing a structure of a vehicle-installed electronic apparatus including a receiver according to an embodiment of the invention.

As shown in this figure, the electronic apparatus 1, which is installed in a vehicle for performing processes for the RKE system (remote keyless entry system), SMART system (smart keyless entry system) and TPM system (tire air pressure monitoring system), includes a receiver 3 for receiving three kinds of radio waves for these three systems, and a control device 5 for performing control processings for these systems. The control device 5 has a microcomputer 7 controlling the entire operation of the control device 5.

The control device 5 is connected to the receiver 3, a door lock motor 31 acting to lock and unlock the door of the vehicle, a door lock sensor 32 for detecting a lock/unlock state of the door, a door-open detecting switch 33 for detecting an open/close state of the door, a door sensor 35 for detecting a human touch on a predetermined portion of the door, a vehicle speed sensor 37 for detecting the speed of the vehicle, an alarm lamp 39, and a transmitter 45 for transmitting a SMART communication request signal (to be explained later). The alarm lamp 39 and the buzzer 41 are for informing a user of the vehicle of a lowering of a tire air pressure of any of the wheels of the vehicle. Although not shown in FIG. 1, the control device 5 receives an ignition switch signal indicative of an on/off state of an ignition switch of the vehicle.

The door lock motor 31, door lock sensor 32, and door-open detecting switch 33 are provided for each of the doors of the vehicle, respectively. The door sensor 35 is provided only for the door of the driver's seat, however, it may be provided for each of the doors. The alarm lamp 39 is provided for each of the doors in a location well visible from a driver of the vehicle, for example, within a meter panel of the vehicle.

Although the RKE system, SMART system, and TPM system are well known per se, they are outlined below while explaining the operation of the vehicle-installed electronic apparatus 1.

RKE System

When the user of the vehicle pushes a button 43a or 43b of a portable device 43, the portable device 43 transmits a radio wave containing vehicle-specific distinction information for distinguishing the RKE system (referred to as “RKE wave” hereinafter). Upon verifying that the distinction information contained in the RKE wave transmitted from the portable device 43 and received by the receiver 3 coincides with corresponding distinction information prestored in the vehicle-installed electronic apparatus 1, the control device 5 drives the door lock motors 31 to lock or unlock all the doors depending on which of the buttons 43a, 43b the user has pushed.

About the SMART System

In the SMART system, the control device 5 controls the transmitter 45 to transmit a SMART communication request signal at regular intervals.

When the portable device 43 enters the communication range and receives the SMART communication request signal, it transmits a radio wave containing vehicle-specific distinction information for distinguishing the SMART system (referred to as “SMART wave” hereinafter) as a response signal. Upon detecting that the distinction information contained in the SMART wave transmitted from the portable device 43 and received by the receiver 3 coincides with corresponding distinction information prestored in the vehicle-installed electronic apparatus 1, the control device 5 allows the doors to be unlocked. The control device 5 drives the door motors 31 to unlock all the doors when it has detected that the user has touched a knob of the door of the driver's seat on the basis of the output signal of the door sensor 35 if the doors have been allowed to be unlocked.

If it is found that the SMART wave is no longer received by the receiver 3 while the vehicle is in a parked state, the control device 5 judges that the user has left from the vehicle, and automatically drives the door lock motors 31 to lock all the doors.

TPM System

In the TPM system, a sensor 47 for detecting a tire air pressure is provided for each of the wheels. The sensor 47 transmits, as a TPM wave, a radio wave containing air pressure data representing a detected tire air pressure and wheel-distinction information showing which one of the wheels is related to this air pressure data in a timing determined so as not to overlap with other TPM waves transmitted from other sensors 47 at regular time intervals. The control device 5 monitors the tire air pressure for each of the wheels on the basis of the TPM waves transmitted from the sensors 47 and received by the receiver 3. If it is detected that the tire air pressure of any of the wheels has fallen below a predetermined value, then the control device 5 lights the alarm lamp 39 associated with the detected wheel and sounds the buzzer 41.

As already explained, the frequency band (315 MHz in this embodiment) and the modulation scheme (FSK modulation in this embodiment) of the RKE wave and the SMART wave transmitted from the portable device 43 are the same as those of the TPM waves transmitted from the sensors 47. However, they are different from one another in the frequency of the baseband signal (communication bit rate).

In the RKE system, the sensitivity (communication range) has higher priority than the system response, and accordingly the communication bit rate is set low compared to the SMART system and the TPM system. The frequency of the baseband signal of the RKE system is set at 0.5 kHz in this embodiment.

In the TPM system, the system response has higher priority than the sensitivity, and accordingly the communication bit rate is set high compared to the SMART system and the RKE system. The frequency of the baseband signal of the TPM system is set at 2.5 kHz in this embodiment.

The SMART system has to have the system response faster than that of the RKE system, and the sensitivity higher than that of the TPM system. Accordingly, the communication bit rate of the SMART system is set at a value larger than that set in the RKE system and smaller than that set in the TPM system. The frequency of the baseband signal of the SMART system is set at 1.25 kHz in this embodiment.

The cut-off frequency (Hz) of the baseband filter is set twice the communication bit rate (bps) in this embodiment.

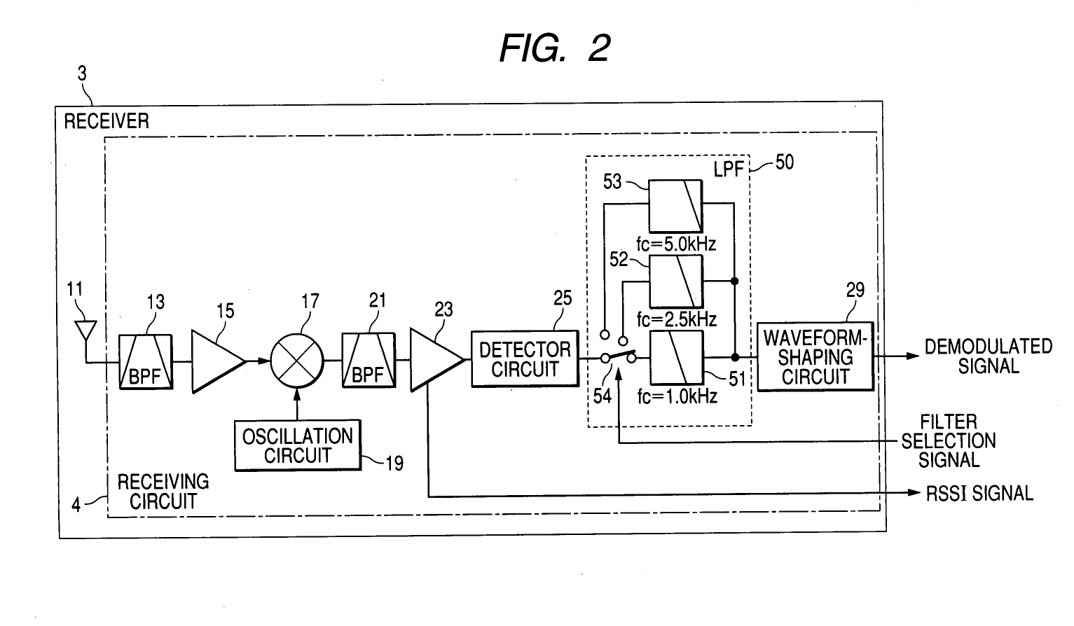

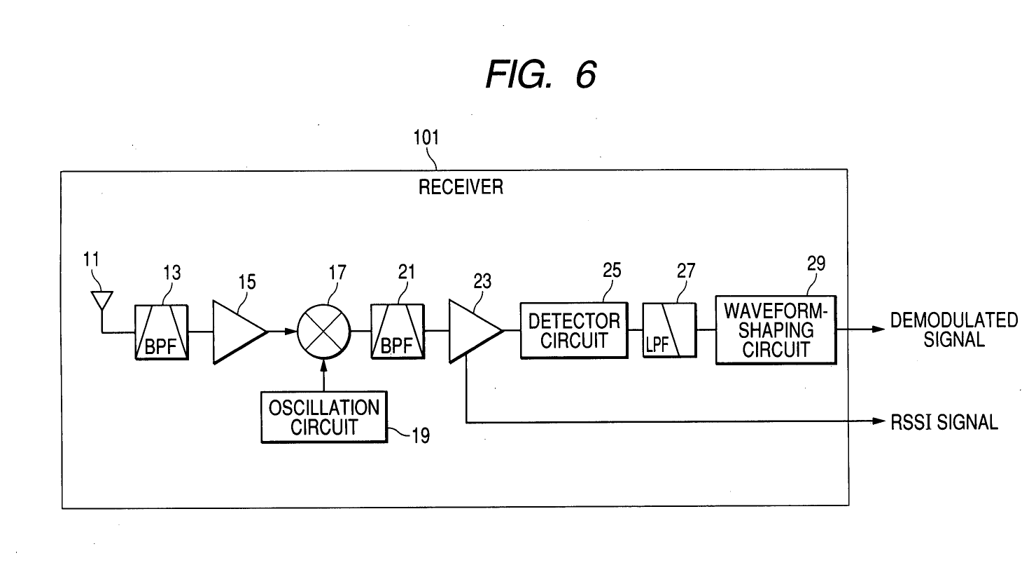

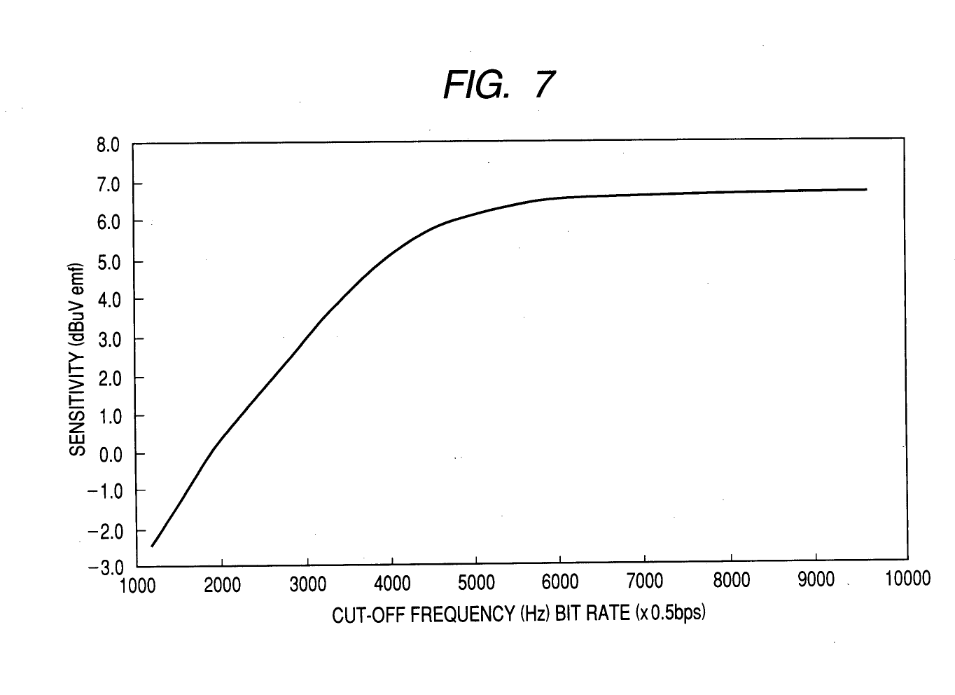

FIG. 2 is a block diagram showing a structure of a receiving circuit 4 of the receiver 3 included in the vehicle-installed electronic apparatus 1. In FIG. 2, the elements that are the same as those shown in FIG. 6 are given the same reference numerals, and explanations thereof are omitted.

The receiver 3 of this embodiment is different from the receiver 101 shown in FIG. 6 in that the receiver 3 has an LPF device 50 whose cut-off frequency (fc) is variable instead of the LPF 27 whose cut-off frequency is fixed.

The LPF device 50 is constituted by an LPF 51 having a cut-off frequency of 1 kHz for the RKE system, an LPF 52 having a cut-off frequency of 2.5 kHz for the SMART system, an LPF 53 having a cut-off frequency of 5 kHz for the TPM system, and a selector switch 54 for selecting one of the LPFs 51, 52, 53 in accordance with a filter selection signal supplied from outside the receiver 3. An output signal from selected one of the LPFs 51, 52, 53 is supplied to the waveform shaping circuit 29.

The filter selection signal may be a 2-bit signal in which “01” designates the LPF 51, “10” designates the LPF 52, and “11” designates the LPF 53, for example. The receiving circuit 4 of the receiver 3 is supplied with a power supply voltage from the control circuit 5.

Next, explanation is made as to how the control device 5 controls the receiver 3.

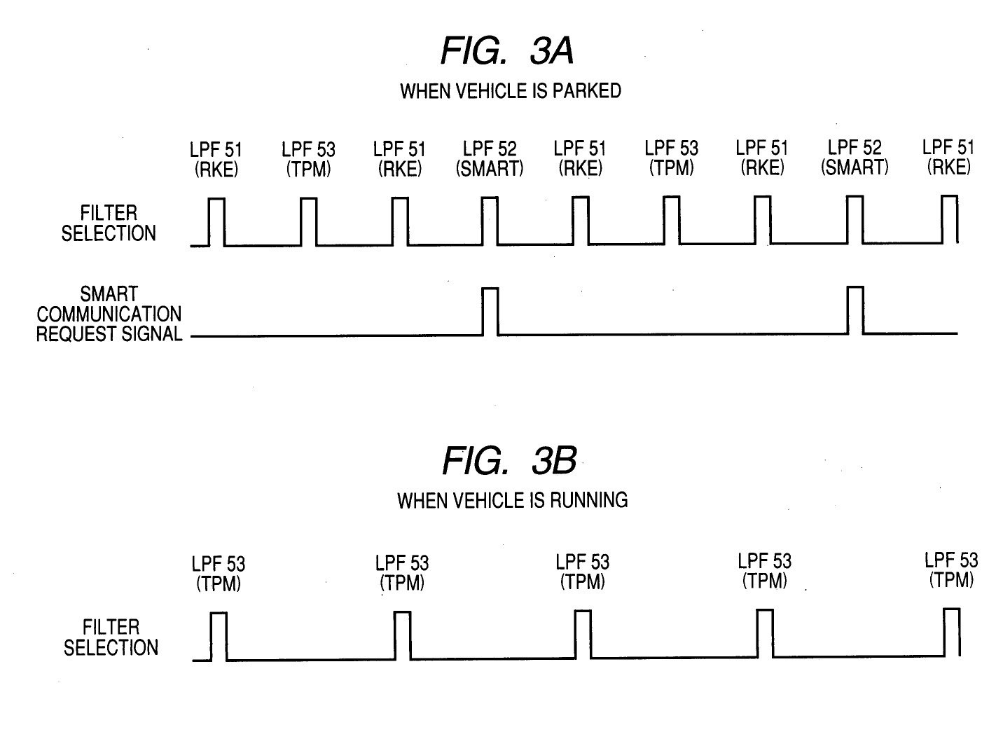

FIG. 3A shows signal-receiving operations periodically performed by the control device 5 while the vehicle is in a parked state where the ignition switch is off and all the doors are in a closed state. The filter selection signal supplied to the receiver 3 is changed for each successive signal-receiving operation, so that the receiver 3 receives the radio waves of the three systems in the repeated sequence of RKE wave→TPM wave→RKE wave→SMART wave.

For obtaining information contained in the RKE wave, the control device 5 controls the selector switch 54 to select the LPF 51 of the LPF device 50 by use of the filter selection signal, so that the baseband signal outputted from the detector circuit 25 enters the LPF 51. For obtaining information contained in the SMART wave, the control device 5 controls the selector switch 54 to select the LPF 52 of the LPF device 50 by use of the filter selection signal, so that the baseband signal outputted from the detector circuit 25 enters the LPF 52. For obtaining information contained in the TPM wave, the control device 5 controls the selector switch 54 to select the LPF 53 of the LPF device 50 by use of the filter selection signal, so that the baseband signal outputted from the detector circuit 25 enters the LPF 53.

As shown in FIG. 3A, when the control device 5 controls the selector switch 54 to select the LPF 52 for the receiver to receive the SMART wave, the control device 5 also controls the transmitter 45 to transmit the SMART communication request signal, because the SMART wave is transmitted from the portable device 43 as a response to the SMART communication request signal.

The above described signal-receiving operations are performed periodically by the control device 5 while the microcomputer 7 thereof judges that the ignition switch is in the off state and all the doors are in the closed state on the basis of the ignition switch signal and the output signals of the door-open detecting switches 33. The microcomputer 7 is configured to enter a sleep mode if a predetermined sleep condition is satisfied for the purpose of reducing electric power consumption. In this embodiment, the sleep condition is that the ignition switch signal indicates that the ignition switch is in the off state, and the output signals of the door-open detecting switches 33 indicate that all the doors are in the closed state. However, even while the sleep condition is satisfied, the microcomputer 7 wakes up from the sleep mode on a temporary basis to perform the above described signal-receiving operations.

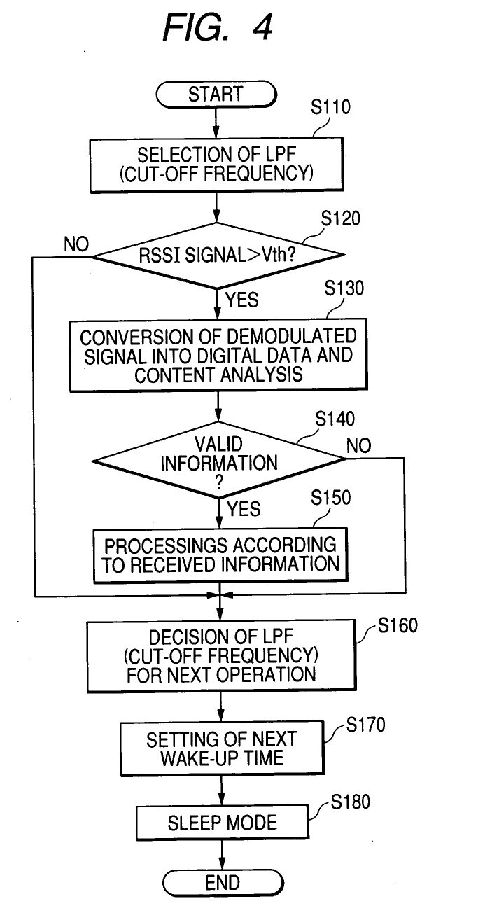

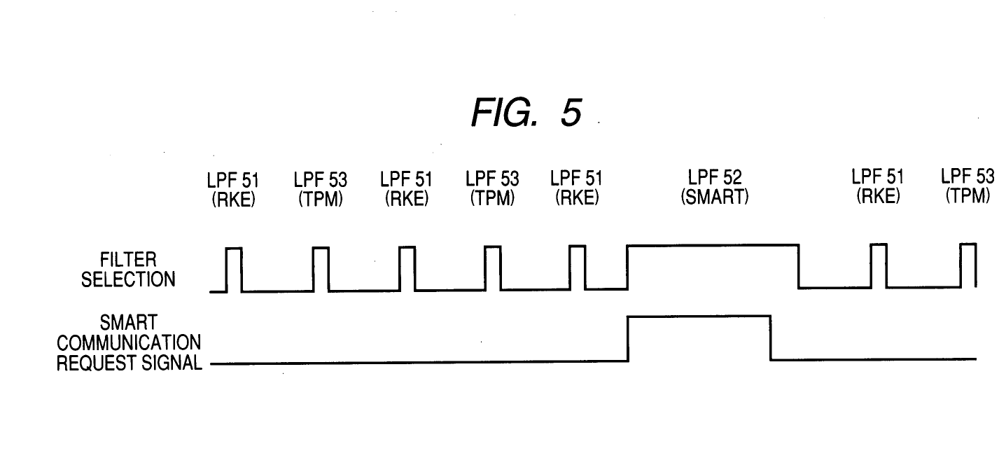

FIG. 4 is a flowchart showing the operation of the microcomputer 7 of the control device 5 while the sleep condition is satisfied.

When the microcomputer 7 wakes up from the sleep mode, it supplies the receiver 3 with the filter selection signal to designate which one of the LPF 51, 52, 53 should be selected (step S110). If the LPF 52 is to be selected (that is, if it is intended for the receiver 3 to receive the SMART wave for the current receiving operation), the SMART communication request signal is transmitted from the transmitter 45 at this step S110.

Subsequently, it is judged whether or not the level of the RSSI signal outputted from the receiver 3 is higher than a predetermined threshold level Vth (step S120). Here, as long as the intended radio wave (315 MHz-band radio wave) is received by the antenna 11 of the receiver 3, the level of the RSSI signal exceeds the threshold level Vth, and the process moves to step S130.

At step S130, the demodulated signal outputted from the receiver 3 is converted into binary digital data on the basis of signal levels (high level/low level), or time intervals between signal edges, and the contents of the binary data (referred to as received data hereinafter) are analyzed. In a case where a coding scheme used for these three systems is such that the communication bit rate (that is, a bit time width) has to be known to convert the demodulated signal (baseband signal) into the digital data, one of the communication bit rates of these three systems may be used for the conversion. For example, when the LPF 51 is selected at step S110, the communication bit rate of the RKE system can be used for the conversion, and when the LPF 53 is selected at step S110, the communication bit rate of the TPM system can be used for the conversion. In a case where the RKE, TPM, and SMART systems use different coding schemes, the demodulated signal is converted into digital data at step S130 by a method corresponding to one of these different coding schemes selected depending on which one of the LPF 51, 52, 53 has been selected at step S110.

Next, it is determined at step 140 whether or not the received data contains valid information. More specifically, at step S140, it is determined whether or not the system distinction information (the distinction information for distinguishing the RKE system if the LPF 51 has been selected, the distinction information for distinguishing the SMART system if the LPF 52 has been selected, the tire air pressure data and wheel-distinction information if the LPF 53 has been selected) is contained in the received data.

If it is determined that the received data contains valid information at step S140, then the process moves to step S150 where information processings according to the valid information are performed.

For example, if the LPF 51 has been selected at step S110 to receive the RKE wave, and it has been determined that the RKE-distinction information contained in the received data coincides with the corresponding vehicle-specific distinction information, the door lock motors 31 are driven to lock or unlock all the doors depending on which of the buttons 43a and 43b of the portable device 43 has been pressed.

If the LPF 52 has been selected at step S110 to receive the SMART wave, and it has been determined that the SMART-distinction information contained in the received data coincides with the corresponding vehicle-specific information, the doors are allowed to be unlocked. And when a human touch on the knob of the door of the driver's seat is detected, the door lock motors 31 are driven to unlock all the doors.

If the LPF 53 has been selected at step S110 to receive the TPM wave, and the tire air pressure of each wheel has been determined on the basis of the tire air pressure data and the wheel-distinction information contained in the received data, it is supplied to a memory such as a RAM for record update. The microcomputer 7 reads the tire air pressure of each of the wheels at a specific timing (when the ignition switch is turned on, for example), and, in the case of detecting that the tire air pressure of any of the wheels is below a predetermined value, operates to light corresponding one of the alarm lamps 41 and to sound the buzzer 41.

After that, the process moves to step S160 where a decision on which one of the LPF 51, 52, 53 should be selected for the next time receiving operation is made. In this embodiment, since the different kinds of radio waves of the three systems are received in the successive sequence of RKE wave→TPM wave→RKE wave→SMART wave, the decision is made so that the LPF 51, 52, 53 are selected one by one in the successive sequence of LPF 51→LPF 53→LPF 51→LPF 52. At step S110 in the next time signal receiving operation, one of the LPF 51, 52, 53 is selected on the basis of the decision made at step S160 in the previous signal receiving operation. In a case where the transmission of the SMART communication request signal has been initiated at step S110, it is ceased at this step S160.

Next, at step S170, the microcomputer 7 sets a time in an internal timer at which the microcomputer 7 should wake up to perform the signal receiving operation again, and then enters the sleep mode(step S180).

When the set time arrives, the microcomputer 7 wakes up from the sleep mode, and again performs the signal receiving operation shown in FIG. 4. The above described set time may be a current time plus a predetermined time. In this case, a time period over which the microcomputer 7 is in the sleep mode becomes constant. Alternatively, the above described set time may be the time at which the microcomputer has woken up plus a predetermined time. In this case, the signal receiving operation shown in FIG. 4 is performed at constant time intervals.

If it is judged at step 120 that the level of the RSSI signal outputted from the receiver 3 is not higher than the threshold level Vth, then the process directly moves to step S160, because it means that the radio wave of the intended frequency band is not being received by the antenna 11.

Also, if it is judged at step S140 that the received data does not contain any valid information, then the process directly moves to step S160, because it means that any of the RKE wave, TPM wave, and SMART wave is not being received normally.

Although not shown in FIG. 4, the microcomputer 7 counts the number of Consecutive times that the process has not moved to step S150 even though the LPF 52 was selected at step S110. And if the counted number has reached a predetermined value, the microcomputer 7 judges that the user has left from the vehicle, and drives the door lock motors 31 to lock all the doors if the doors have been detected to be in the unlocked state on the basis of the output signals of the door lock sensors 32.

As shown in FIG. 3B, the control device 5 performs the signal receiving operations periodically also when the vehicle is running. However, while the vehicle is running, only the LPF 51 is selected so that the receiver 3 receives only the TPM wave. Accordingly, when the vehicle is running, the operations similar to those of steps S120 to S150 in FIG. 4 are performed, and, in the case of the tire air pressure of any of the wheels being detected to be below the predetermined value, the microcomputer 7 operates to light corresponding one of the alarm lamps 41 and to sound the buzzer 41.

The periodical signal receiving operations shown in FIG. 3B may by performed while the microcomputer 7 detects, on the basis of the output signal of the vehicle speed sensor 37, that the vehicle speed is over a certain threshold speed, or while the microcomputer 7 detects that the ignition switch is on, and therefore assumes the vehicle to be running.

As explained above, in the vehicle-installed electronic apparatus according to this embodiment of the invention, the cut-off frequency of the LPF 50 device is variable. More specifically, the control device 5 selects, by use of the filter selection signal, the LPF 51 having the cut-off frequency of 1 kHz at the time of receiving the RKE wave, selects the LPF 52 having the cut-off frequency of 2.5 kHz at the time of receiving the SMART wave, and selects the LPF 53 having the cut-off frequency of 5 kHz at the time of receiving the TPM wave. Accordingly, it becomes possible to enhance the sensitivity (communication range) when receiving the RKE wave of the RKE system having the low communication bit rate (low baseband signal frequency), to enhance the system response when receiving the TPM wave of the TPM system having the high communication bit rate, and to set the sensitivity and the system response at moderate levels when receiving the SMART wave of the SMART system having the moderate communication bit rate.

As a consequence, it becomes possible to receive radio waves of these three different systems by use of the single receiver 3, and perform the operations required of them by use of the single control device 5. Accordingly, the vehicle-installed electronic apparatus according to this embodiment can be made smaller in size.

### Variant of the Embodiment

The control device 5 may be so configured as to alternately select between the LPF 51 and LPF 53 (that is, to alternately change the cut-off frequency of the LPF device 50 between 1 kHz and 5 kHz) so that the receiver 3 receives the RKE wave and the TPM wave by turns, as to cause the transmitter 45 to transmit the SMART communication request signal upon detecting a human touch on the knob of the door of the driver's seat, while concurrently selecting the LPF 52 (setting the cut-off frequency of the LPF device 50 at 2.5 kHz) so that the receiver 3 receives the SMART wave, and as to cause the door lock motors 31 to lock the doors if the SMART distinction information contained in the received data coincides with the corresponding vehicle-specific distinction information.

Although the receiver 3 of the vehicle-installed electronic apparatus according to the above described embodiment of the invention is configured to receive three kinds of radio waves for the three systems (RKE system, SMART system, and TPM system), it maybe configured to receive two of them, or to receive a radio wave of a different system.

The output signal of the LPF device 50 may be directly supplied as the demodulated signal to the control device 5 to eliminate the waveform shaping circuit 29 from the receiver 3, if some circuit equivalent to the waveform shaping circuit 29 can be provided on the side of the control circuit 5.

The LPF device 50 may be configured such that the cut-off frequency thereof varies as a resistance or a capacitance of an element constituting the LPF device 50 varies in accordance with a command received from outside.

The above explained preferred embodiments are exemplary of the invention of the present application which is described solely by the claims appended below. It should be understood that modifications of the preferred embodiments may be made as would occur to one of skill in the art.

1. A receiver comprising:
an antenna receiving a radio wave transmitted from a communication target;
a demodulator extracting a baseband signal from said radio wave received by said antenna; and
a filter device low-pass filtering said baseband signal extracted by said demodulator, said filter device being configured to vary a cut-off frequency thereof in accordance with a command signal received from outside said receiver.

2. A receiver according to claim 1, wherein said filter device includes a plurality of low-pass filters having different cut-off frequencies, and a selector switch that selects one of said plurality of said low-pass filters in accordance with said command signal.

3. A receiver according to claim 1, further comprising a waveform-shaping circuit for shaping a waveform of said baseband signal low-pass filtered by said filter device.

4. An electronic apparatus comprising:
a receiver including;
an antenna receiving a radio wave transmitted from a communication target;
a demodulator extracting a baseband signal from said radio wave received by said antenna; and
a filter device low-pass filtering said baseband signal extracted by said demodulator, said filter device being configured to vary a cut-off frequency thereof in accordance with a command signal received from outside said receiver;
and
a control device outputting said command signal to said receiver in order that said receiver receives, on an alternating basis, different kinds of radio waves, which have the same frequency band, are modulated by the same modulation scheme, and are different in a baseband-signal frequency, for obtaining information contained in said different kinds of said radio waves.

5. An electronic apparatus according to claim 4, wherein said filter device includes a plurality of low-pass filters having different cut-off frequencies, and a selector switch that selects one of said plurality of said low-pass filters in accordance with said command signal.

6. An electronic apparatus according to claim 4, wherein said receiver further includes a waveform-shaping circuit for shaping a waveform of said baseband signal low-pass filtered by said filter device.

7. An electronic apparatus according to claim 4, wherein said electronic apparatus is of vehicle-installed type, said communication target is a portable device carried by a user of a vehicle, and said different kinds of said radio waves includes at least two of a radio wave for a remote keyless entry system transmitted from said portable device, a radio wave for smart keyless entry system transmitted from said portable device, and a radio wave for a tire air pressure monitoring system transmitted from a sensor installed in each of wheels of said vehicle.
